(19) United States
(12) Patent Application Publication
(10) Pub. No.: US 2026/0099114 A1
(43) Pub. Date: Apr. 9, 2026

(54) STORAGE CONTAINER AND IMAGE FORMING APPARATUS

(71) Applicant: SHARP KABUSHIKI KAISHA, Sakai City (JP)

(72) Inventor: Kunihiro Mitsuhashi, Sakai City (JP)

(21) Appl. No.: 19/351,623

(22) Filed: Oct. 7, 2025

(30) Foreign Application Priority Data
Oct. 8, 2024 (JP) 2024-176449

(51) Int. Cl. G03G 15/08; G03G 21/16

(52) U.S. Cl. CPC G03G 15/0865; G03G 21/1647; G03G 2221/1654

(57) ABSTRACT

A storage container for toner is inserted into a housing of an image forming apparatus in an insertion direction. The storage container includes a grip portion that grips a gripped portion provided in the housing, a movement restriction portion that is locked to a locking portion provided in the housing and restricts movement in the insertion direction.

### CROSS-REFERENCE TO RELATED APPLICATION

The present application claims priority from Japanese Application JP2024-176449, the content of which is hereby incorporated by reference into this application.

### BACKGROUND OF THE INVENTION

### 1. Field of the Invention

The disclosure relates to a storage container and an image forming apparatus.

### 2. Description of the Related Art

An electrophotographic image forming apparatus is known. In such an image forming apparatus, an image is formed (printed) using toner contained in a cartridge (storage container). The toner is consumed during image formation, and the toner contained in the cartridge is finally exhausted. The empty cartridge is removed from the image forming apparatus, and a new cartridge is mounted. It is preferable that the cartridge is normally housed in the image forming apparatus. In the related art, an image forming apparatus in which workability at the time of replacing a cartridge is taken into consideration has been proposed.

### SUMMARY

A known image forming apparatus includes a toner container attachable to an attachment position defined in an apparatus body, a support member that supports the toner container so that the toner cartridge can be moved to a detachment position separated from the attachment position toward a predetermined first surface, a lock member that is displaced between a lock position in which the toner container is locked at the attachment position and a release position in which the lock of the toner container is released, a lock release portion that releases the lock of the toner container when a release condition is satisfied, an elastic member that biases the lock member toward the lock position, and a movement mechanism that moves the toner container toward the detachment position in accordance with the release of the lock.

The known image forming apparatus is configured such that the toner container is locked only by the lock member; therefore, when the lock member is displaced when receiving a load or the like, the toner container is likely to be unexpectedly unlocked.

An aspect of the disclosure has been made to solve the above-described problem, and an object of the disclosure is to provide a storage container and an image forming apparatus that are capable of suppressing detachment even when receiving a load.

A storage container according to an aspect of the disclosure is a storage container for toner to be inserted into a housing of an image forming apparatus in an insertion direction, the storage container including: a grip portion that grips a gripped portion provided in the housing; a movement restriction portion that is locked to a locking portion provided in the housing and restricts movement in the insertion direction.

The storage container according to an aspect of the disclosure may include: a container facing surface that is orthogonal to the insertion direction and faces the housing; a container side surface along the insertion direction; and a detachable member provided with the grip portion and the movement restriction portion. The detachable member may include a detachable facing portion along the container facing surface and a detachable side surface portion along the container side surface, and the grip portion and the movement restriction portion may be provided on the detachable side surface portion.

In the storage container according to an aspect of the disclosure, the detachable member may be provided with a fixing portion on the detachable facing portion, the fixing portion being fixed to the container facing surface, and when the detachable side surface portion is pressed and moved, locking of the grip portion and the movement restriction portion may be released.

In the storage container according to an aspect of the disclosure, the detachable side surface portion may include a pressing portion that is pressed by a user when moving the detachable side surface portion, and the pressing portion may be disposed on a straight line passing through the grip portion along the insertion direction.

In the storage container according to an aspect of the disclosure, when a direction parallel to the container facing surface and orthogonal to the insertion direction is defined as a lever direction, the detachable side surface portion may have one end portion in the lever direction, which is connected to the detachable facing portion, and the other end portion in the lever direction at which the movement restriction portion is provided.

In the storage container according to an aspect of the disclosure, the fixing portion may be provided at a portion of the detachable facing portion, which is connected to the detachable side surface portion, and the grip portion may be provided between the fixing portion and the movement restriction portion in the lever direction.

In the storage container according to an aspect of the disclosure, the movement restriction portion may be movably attached, and may be moved to be switched between a state of being locked to the locking portion and a state of being unlocked from the locking portion.

An image forming apparatus according to an aspect of the disclosure includes the storage container according to the disclosure.

In the image forming apparatus according to an aspect of the disclosure, the gripped portion may have an end portion on a side facing a side surface of the storage container, the end portion being formed in a tapered shape that is inclined.

The image forming apparatus according to an aspect of the disclosure may include a biasing member that biases the storage container mounted in the housing. The insertion direction may be opposite to a biasing direction of the biasing member.

According to an aspect of the disclosure, even when force is applied in a direction in which the grip portion is detached due to a load or the like, the storage container is restrained by the movement restriction portion.

Therefore, according to an aspect of the disclosure, the storage container and the image forming apparatus that can prevent the storage container from being detached from the housing can be provided.

### BRIEF DESCRIPTION OF THE DRAWINGS

FIG. 1 is a schematic cross-sectional view illustrating a configuration of an image forming apparatus according to an embodiment of the disclosure.

FIG. 2 is a perspective view illustrating a storage container and a housing connector as viewed from the front side.

FIG. 3 is a perspective view illustrating the storage container and the housing connector as viewed from the rear side.

FIG. 4 is a side view illustrating the storage container when mounting the storage container to the housing connector.

FIG. 5 is a rear view of the storage container.

FIG. 6 is an enlarged perspective view of the storage container in which a location near a detachable member is enlarged.

FIG. 7 is an enlarged perspective view illustrating the housing connector.

FIG. 8 is a side view illustrating the detachable member and the housing connector that are locked to each other, as viewed from the housing connector side.

FIG. 9 is a side view illustrating the detachable member and the housing connector that are locked to each other, as viewed from the detachable member side.

FIG. 10 is a perspective view illustrating the detachable member and the housing connector that are locked to each other.

FIG. 11 is a side view illustrating the detachable member and the housing connector in a modification.

### DETAILED DESCRIPTION OF THE INVENTION

An image forming apparatus according to an embodiment of the disclosure will be described below with reference to the accompanying drawings.

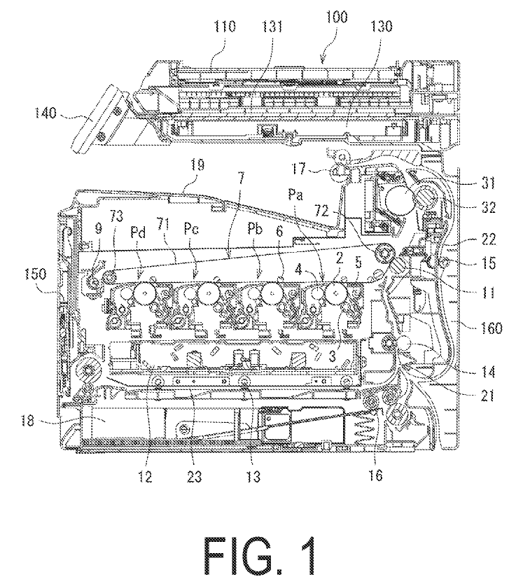

FIG. 1 is a schematic cross-sectional view illustrating a configuration of the image forming apparatus according to the embodiment of the disclosure.

An image forming apparatus 100 is a multi-function printer that has a copy function, a scanner function, a facsimile function, and a printer function. The image forming apparatus 100 transmits an image of a document read by an image reader 130 to an external device, or forms an image of a document read by the image reader 130 or an image received from the external device, on a recording medium such as a sheet in color or monochrome.

A document feeding device 110 supported in an openable/closable manner is provided on the upper side of the image reader 130. The document feeding device 110 feeds one document or a plurality of documents one by one sequentially. The image reader 130 generates image data by allowing a scanning optical system to scan a document placed on a document table 131 to read the document, or by reading a document fed by the document feeding device 110.

The image forming apparatus 100 includes a fixing device, a photoreceptor drum 2, a charger 3, a development device 4, a drum cleaning device 5, an intermediate transfer belt device 7, a secondary transfer roller 11, an optical scanning device 12, a feeder 18, etc.

The image forming apparatus 100 handles image data corresponding to a color image composed of the colors black (K), cyan (C), magenta (M), and yellow (Y), or a monochrome image composed of a single color (for example, black). The image forming apparatus 100 is provided with four of the photoreceptor drums 2, four of the chargers 3, four of the development devices 4, and four of the drum cleaning devices 5 to form four types of toner images and respectively serve as four image stations Pa, Pb, Pc, Pd corresponding to the colors black, cyan, magenta, and yellow, respectively.

The charger 3 uniformly charges the surface of the photoreceptor drum 2 to a predetermined potential. The optical scanning device 12 exposes the surface of the photoreceptor drum 2 to form an electrostatic latent image. The development device 4 develops the electrostatic latent image on the surface of the photoreceptor drum 2 to form a toner image on the surface of the photoreceptor drum 2. The drum cleaning device 5 removes and collects residual toner on the surface of the photoreceptor drum 2. With a sequence of operations described above, a toner image of each color is formed on the surface of each photoreceptor drum 2.

The intermediate transfer belt device 7 includes intermediate transfer rollers 6, an endless intermediate transfer belt 71, an intermediate transfer driving roller 72, an intermediate transfer driven roller 73, and a cleaning device 9. Four of the intermediate transfer rollers 6 are provided on the inner side of the intermediate transfer belt 71 to form four types of toner images corresponding to the respective colors. The intermediate transfer rollers 6 transfer the toner images of the respective colors formed on the surfaces of the photoreceptor drums 2 to the intermediate transfer belt 71 that is moving in a circularly rotating manner.

The intermediate transfer belt 71 is stretched over the intermediate transfer driving roller 72 and the intermediate transfer driven roller 73. In the image forming apparatus 100, the toner images of the respective colors formed on the surfaces of the respective photoreceptor drums 2 are sequentially transferred and superimposed to form color toner images on the surface of the intermediate transfer belt 71. The cleaning device 9 removes and collects waste toner that remains on the surface of the intermediate transfer belt 71 without being transferred to the sheet.

The secondary transfer roller 11 is configured such that the sheet conveyed through a sheet conveying path 21 is conveyed while being nipped at a transfer nip portion between the intermediate transfer belt 71 and the secondary transfer roller 11. When the sheet passes through the transfer nip portion, the toner image on the surface of the intermediate transfer belt 71 is transferred onto the sheet, and the sheet is conveyed to the fixing device.

The fixing device includes a fixing roller 31 and a pressure roller 32 that rotate around an axis. The fixing device is configured such that the sheet with the transferred toner image is nipped by a nip portion between the fixing roller 31 and the pressure roller 32 and subjected to heat and pressure, and thus the toner image is fixed onto the sheet.

The feeder 18 is provided with a feed cassette in which recording media (sheets) to be used for image formation are stacked, and is disposed below the optical scanning device 12. The sheet is pulled out from the feeder 18 by pickup rollers 16 and conveyed to the sheet conveying path 21. The sheet conveyed to the sheet conveying path 21 is discharged to a discharge tray 19 by discharge rollers 17 via the secondary transfer roller 11 and the fixing device.

Registration rollers 14 and the discharge rollers 17 are disposed along the sheet conveying path 21. The registration rollers 14 convey the sheet at a speed equal to a process speed at which an image is formed on the sheet. The registration rollers 14 are provided between the feeder 18 and the secondary transfer roller 11, and adjust a conveyance timing of the sheet so that the toner image is transferred to the sheet by the secondary transfer roller 11. For example, the registration rollers 14 allow the conveyed sheet to wait (temporarily stop) while being nipped, and start conveying the sheet at a constant speed in synchronization with the secondary transfer roller 11.

When images are formed on not only the front surface but also the back surface of the sheet, a conveying direction of the sheet is changed by the discharge rollers 17, and the sheet is conveyed to a reverse conveying path 22. In the reverse conveying path 22, the front and back of the sheet are reversed by reverse conveying rollers 15, and the sheet is guided in the reversed state to the registration rollers 14. The image forming apparatus 100 forms the image on the back surface of the sheet guided to the registration rollers 14 in the same manner as the front surface of the sheet, and then discharges the sheet to the discharge tray 19.

A bypass tray 150 is attached to the front face of the image forming apparatus 100 so as to be openable and closable, and an opening/closing door 160 is attached to the rear face of the image forming apparatus 100 so as to be openable and closable. The sheets stacked on the opened bypass tray 150 are supplied to a manual feed conveying path 23 at a location near the front face. The manual feed conveying path 23 merges at a location just before the registration rollers 14 with the sheet conveying path 21 at a location near the rear face, and the sheet is conveyed to the registration rollers 14 by manual feed conveying rollers 13 disposed in the manual feed conveying path 23. When the opening/closing door 160 is opened, the reverse conveying path 22 is exposed, and a jammed sheet or the like can be collected. The feeder 18 is disposed below the manual feed conveying path 23, and is configured to be pulled out from the front side to the outside.

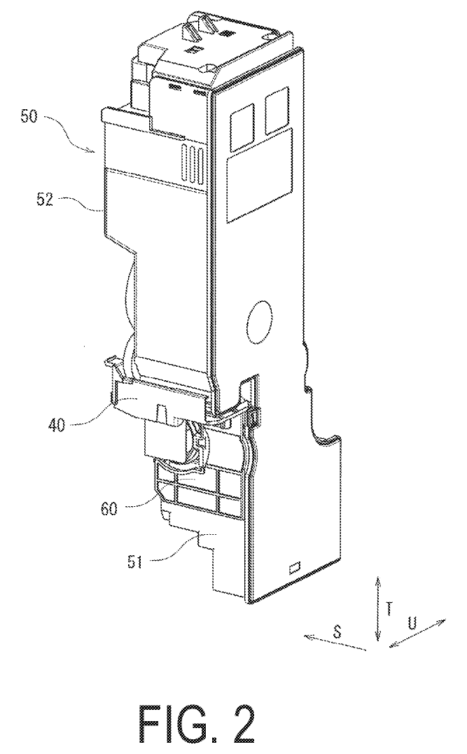

The image forming apparatus 100 is configured such that a storage container 50 (see FIG. 2) that stores toner and waste toner is mounted, and the toner is delivered to the development device 4 and the drum cleaning device 5. In the present embodiment, four of the storage containers 50 are mounted corresponding to respective colors to be used, and each of the storage containers 50 is detachably attached to the image forming apparatus 100. In the following, a housing connector 40 which is a part of a housing of the image forming apparatus 100 and is connected to the storage container 50 is illustrated separately. In the housing of the image forming apparatus 100, a portion corresponding to the storage container 50 may be provided in addition to the housing connector 40.

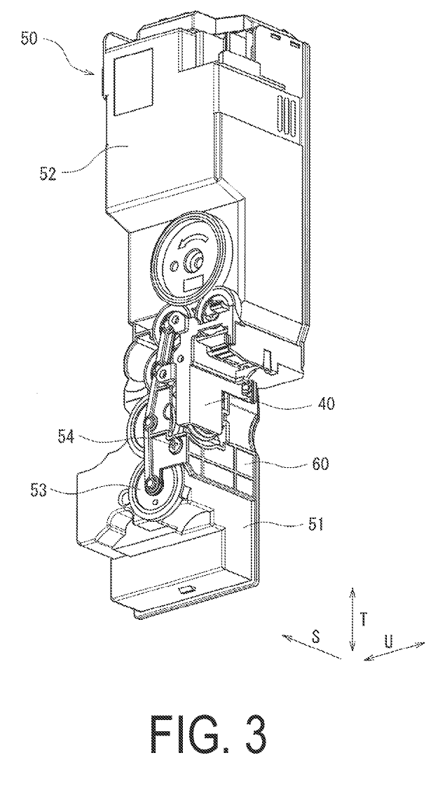

FIG. 2 is a perspective view illustrating the storage container and the housing connector as viewed from the front side, and FIG. 3 is a perspective view illustrating the storage container and the housing connector as viewed from the rear side.

The storage container 50 is a vertically long case having a substantially rectangular parallelepiped shape, and contains toner in a space disposed therein. The internal space of the storage container 50 may be divided into a plurality of spaces, and in the present embodiment, the internal space is divided into two spaces, and new toner and used waste toner are separately contained. In the present embodiment, the storage container 50 is configured to be inserted and attached from a side surface of the housing of the image forming apparatus 100 in a state where the front face is on the near side and the rear face is on the far side. In other words, the rear face of the storage container 50 is a container facing surface 52 that faces the housing when the storage container 50 is mounted in the image forming apparatus 100. Hereinafter, for the sake of explanation, a direction in which the storage container 50 is inserted into the housing of the image forming apparatus 100 at the time of mounting the storage container 50 may be referred to as an insertion direction S. In addition, a vertical direction (longitudinal direction) along the front face (rear face) of the storage container 50 may be referred to as a height direction T (corresponding to a lever direction), and a horizontal direction (short direction) along the front face (rear face) of the storage container 50 may be referred to as a width direction U.

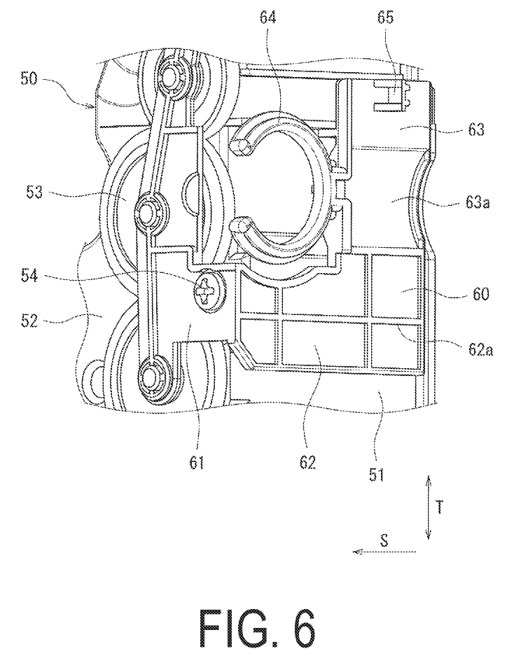

The housing connector 40 is disposed at a position facing one side surface (a container side surface 51) of the storage container 50, and is connected to a detachable member 60 attached to the storage container 50. A plurality of gears 53 are attached to the container facing surface 52, and a screw or the like (not illustrated) disposed inside the storage container 50 rotates as the gears 53 rotate. When being mounted in the image forming apparatus 100, the gears 53 are connected to a driving source (not illustrated) disposed in the image forming apparatus 100, and driving force for rotating the gears 53 is transmitted thereto from the driving source. The detachable member 60 is configured such that an end portion (corresponding to a fixing portion) closer to the container side surface 51 is fixed to the container facing surface 52 by a fixing member 54 such as a screw. Note that a detailed structure of the detachable member 60 and the housing connector 40 will be described with reference to FIGS. 6 to 10 described below.

In the present embodiment, a configuration in which the storage container 50 is mounted such that the longitudinal direction is the vertical direction is described, but not limited thereto, and the direction in which the storage container 50 is mounted to the image forming apparatus 100 may be changed as appropriate.

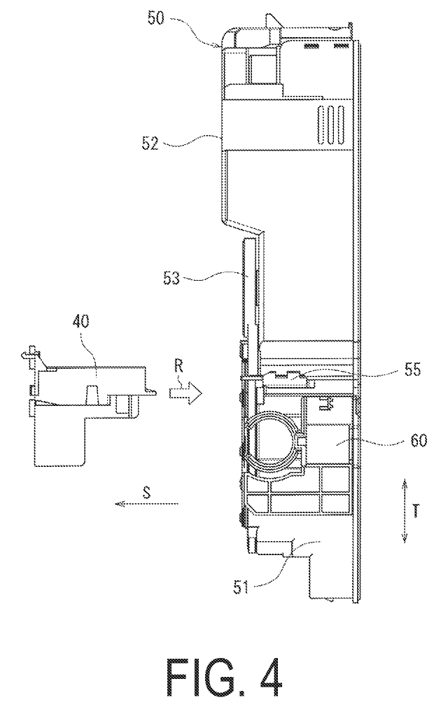

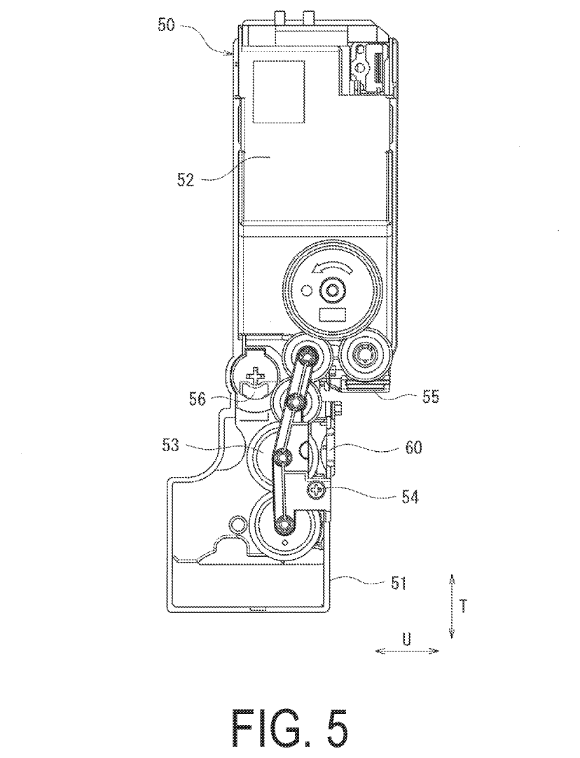

FIG. 4 is a side view illustrating the storage container when mounting the storage container to the housing connector, and FIG. 5 is a rear view of the storage container.

FIG. 4 illustrates a positional relationship when the storage container 50 is inserted into the housing of the image forming apparatus 100 along the insertion direction S in a state where the detachable member 60 and the housing connector 40 are separated from each other. As illustrated in FIG. 4, when mounting the storage container 50 (on the right side in FIG. 4), the storage container 50 is inserted straight along the insertion direction S (toward the left side in FIG. 4) while the position of the detachable member 60 in the height direction T is aligned with the housing connector 40 (on the left side in FIG. 4).

The container side surface 51 is provided with a shutter 55 at a portion corresponding to the housing connector 40. The shutter 55 is attached to the storage container 50 to be openable and closable, and opens and closes a discharge port for toner. In a state where the storage container 50 is detached, the shutter 55 closes the discharge port. When the storage container 50 is mounted in the image forming apparatus 100, the housing connector 40 presses the shutter 55 (rightward in FIG. 4) to bring the discharge port into an open state. The shutter 55 may be provided with a biasing member (not illustrated) that biases the shutter 55 in a direction to close the discharge port (leftward in FIG. 4). The discharge port in the open state is connected to the development device 4 or the like, and the toner contained in the storage container 50 is supplied.

The container facing surface 52 is provided with a receiving unit 56 for toner. When the storage container 50 is mounted, the receiving unit 56 is connected to the drum cleaning device 5 or the like and receives the discharged toner. In the drum cleaning device 5 or the like, a shutter that is openable and closable may be provided in the same way as the storage container 50, and the shutter may be configured to open when the storage container 50 is connected to the receiving unit 56.

As described above, the biasing member that biases the storage container 50 mounted in the housing is provided at a connected portion between the image forming apparatus 100 and the storage container 50. The insertion direction S of the storage container 50 is opposite to a biasing direction R of the biasing member. The way of attaching the biasing member may be changed as appropriate, and the biasing member only needs to act in a direction to separate the storage container 50 from the housing.

FIG. 6 is an enlarged perspective view of the storage container in which a location near the detachable member is enlarged.

The detachable member 60 includes a detachable facing portion 61 along the container facing surface 52 and a detachable side surface portion 62 along the container side surface 51. The detachable facing portion 61 is fixed to the container facing surface 52 by the fixing member 54. The detachable facing portion 61 is connected to a portion that supports the gear 53, which is attached to the container facing surface 52, such that the gear 53 pivots. The detachable member 60 is made of an elastic material such as resin. When a portion of the detachable member 60, which is not fixed to another member, is pressed, the detachable member 60 is deformed and moved. When the load is removed, the detachable member 60 is returned to the original shape.

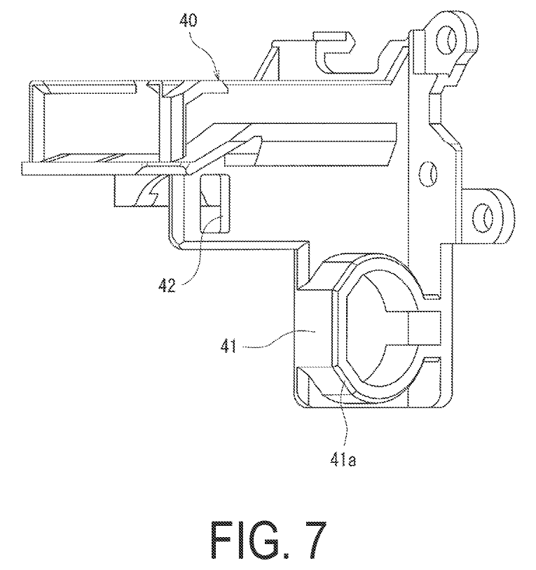

The detachable side surface portion 62 is connected, at a location near the portion fixed by the fixing member 54, to the detachable facing portion 61, and extends from the rear surface side to the front surface side of the storage container 50. An extending portion 63 extending upward is provided at an end portion on the front side of the detachable side surface portion 62. A restriction protrusion 65 (an example of a movement restriction portion) protruding in the width direction U that is a direction away from the container side surface 51 is provided at an upper end of the extending portion 63. The restriction protrusion 65 is inserted into a locking hole 42 (an example of a locking portion, see FIG. 7) provided in the housing connector 40. The restriction protrusion 65 is provided with an inclined surface inclined with respect to the insertion direction S.

As described above, the detachable member 60 is configured such that the detachable facing portion 61 is fixed to the container facing surface 52, but the detachable side surface portion 62 is not fixed to the container side surface 51. The detachable side surface portion 62 is supported with a gap provided between the container side surface 51 and the detachable side surface portion 62, and is pressed toward the container side surface 51 and thus is moved. A pressing portion 63a to be pressed by a user when the detachable side surface portion 62 (in particular, the extending portion 63) is moved is provided on the root side of the extending portion 63 and below the restriction protrusion 65. The pressing portion 63a is configured such that the surface is curved to be recessed toward the container side surface 51 with respect to the surroundings thereof, and is shaped such that the user's finger can be easily placed thereon.

The extending portion 63 is provided with a grip portion 64 extending from the pressing portion 63a along the insertion direction S. The grip portion 64 is a hook formed in a C-shape (C-ring shape), and grips a gripped portion 41 (see FIG. 7) provided at the housing connector 40. The grip portion 64 is open on the distal end side (left side in FIG. 6) in the insertion direction S, and the gripped portion 41 enters the inside of the hook through the open gap. As described above, the pressing portion 63a is disposed on a straight line passing through the grip portion 64 along the insertion direction S. Specifically, the pressing portion 63a is disposed behind the grip portion 64 in the insertion direction S. As just described, the pressing portion 63a is provided near the grip portion 64 and the restriction protrusion 65. Accordingly, the pressing portion 63a is pressed, and thus the grip portion 64 and the restriction protrusion 65 can be smoothly displaced.

As described above, the fixing portion via which the detachable member 60 is fixed to the container facing surface 52 is provided in a portion of the detachable facing portion 61, which connects to the detachable side surface portion 62, and the grip portion 64 is provided between the fixing portion and the restriction protrusion 65 in the height direction T.

A reinforcement rib 62a is provided at a lower portion of the detachable side surface portion 62. The detachable side surface portion 62 is not provided with a fixing portion to the container side surface 51, and preferably maintains strength even with a thin wall so as to be easily moved. Accordingly, by providing the reinforcement rib 62a, the detachable side surface portion 62 is reinforced.

FIG. 7 is a perspective view illustrating the housing connector.

In FIG. 7, the housing connector 40 of a part of the housing of the image forming apparatus 100 is illustratively extracted. The housing connector 40 is disposed at a position facing the container side surface 51 (in particular, the detachable member 60) with respect to the storage container 50 mounted in the image forming apparatus 100. In other words, when the storage container 50 is mounted in the image forming apparatus 100, the detachable member 60 and the housing connector 40 are located adjacent to each other in the width direction U and locked to each other.

The housing connector 40 is provided with the gripped portion 41 corresponding to the grip portion 64 and the locking hole 42 corresponding to the restriction protrusion 65. The gripped portion 41 is a substantially columnar protrusion and is gripped by the grip portion 64 such that the circumferential surface is surrounded by the grip portion 64. The gripped portion 41 has an end portion (a tapered portion 41a) on a side facing the container side surface 51, the end portion having a tapered shape that is C-chamfered and inclined. In the present embodiment, the locking hole 42 is formed such that a part thereof is open, but is not limited thereto, and may be a recessed portion having a size that allows the restriction protrusion 65 to be fitted thereinto. In the present embodiment, the housing connector 40 is provided with the gripped portion 41 and the locking hole 42, but is not limited thereto, and the gripped portion 41 and the locking hole 42 may be disposed on different members.

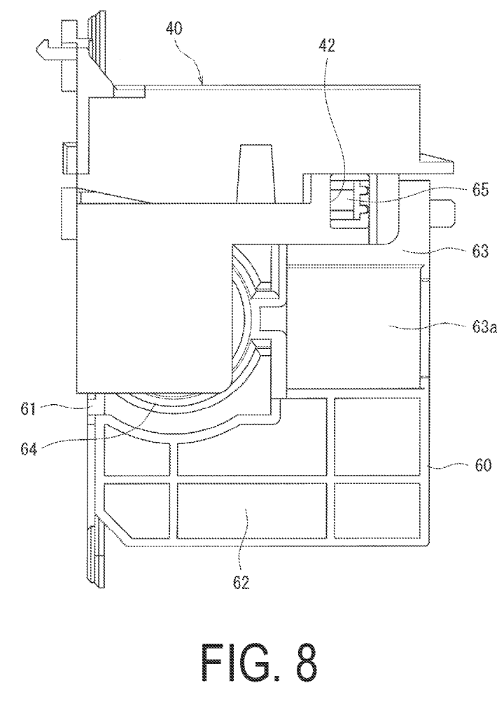

Next, the positional relationship between the detachable member 60 and the housing connector 40 will be described with reference to FIGS. 8 to 10. Note that in FIGS. 8 to 10, the detachable member 60 and the housing connector 40 are illustratively extracted in consideration of the visibility of the drawings.

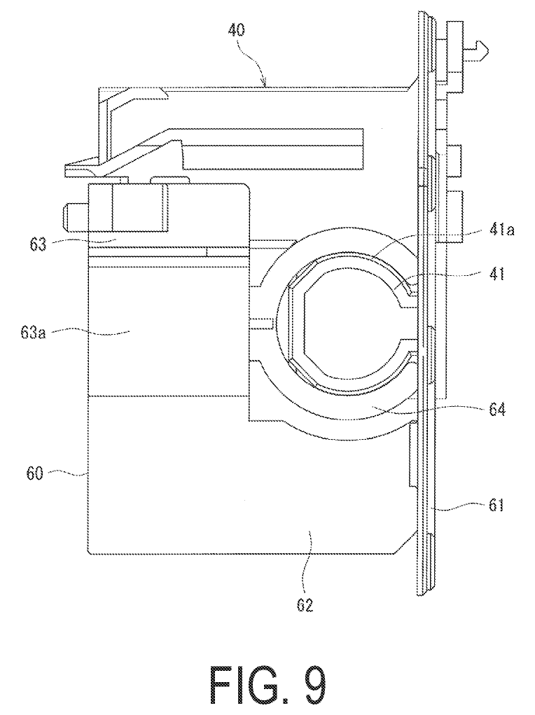

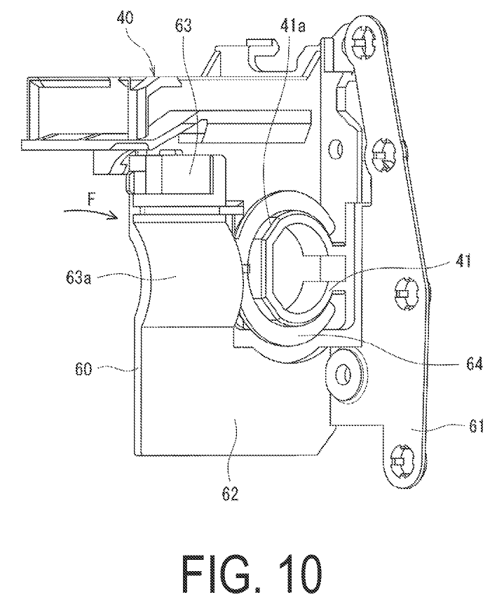

FIG. 8 is a side view illustrating the detachable member and the housing connector that are locked to each other, as viewed from the housing connector side. FIG. 9 is a side view illustrating the detachable member and the housing connector that are locked to each other, as viewed from the detachable member side. FIG. 10 is a perspective view illustrating the detachable member and the housing connector that are locked to each other.

When mounting the storage container 50 in the image forming apparatus 100, as illustrated in FIG. 4, the storage container 50 is inserted in the insertion direction S in a state where the position of the detachable member 60 is aligned with the housing connector 40. When the gripped portion 41 and the grip portion 64 are aligned with each other so that the gripped portion 41 is fitted to the inside of the grip portion 64 (see FIG. 9), the restriction protrusion 65 is fitted into the locking hole 42 (see FIG. 8). Until the restriction protrusion 65 reaches the locking hole 42, the restriction protrusion 65 can be retracted by the inclined surface provided on the restriction protrusion 65 so as not to be caught by the housing connector 40. In other words, the restriction protrusion 65 (movement restriction portion) is locked to the locking hole 42 (locking portion), and the movement of the detachable member 60 in the insertion direction S is restricted. Accordingly, even when force is applied in a direction in which the grip portion 64 is detached due to a load or the like, the storage container 50 is restrained by the movement restriction portion. Therefore, the storage container 50 can be prevented from being detached from the housing. The detachable member 60 is provided with two portions to be locked to the housing connector 40, which are the grip portion 64 and the restriction protrusion 65, on the detachable side surface portion 62, and it is preferable that the detachable side surface portion 62 is not directly fixed to the container side surface 51 so as to be easily moved.

A gap at a distal end of the grip portion 64 is smaller than a diameter (width in the height direction T) of the gripped portion 41, and a gap at a root side of the grip portion 64 is substantially the same as the diameter of the gripped portion 41. The grip portion 64 in a state of gripping the gripped portion 41 is restricted from moving in the insertion direction S and the height direction T unless an extremely strong force is applied. A contact portion between the grip portion 64 and the gripped portion 41 has a curved shape, and the grip portion 64 has elasticity. Therefore, when the gripped portion 41 pushes out the grip portion 64 to enter the inside thereof, the force to return to the original shape acts to pull the gripped portion 41 into the grip portion 64. As just described, by inserting the storage container 50 along the insertion direction S, the grip portion 64 and the restriction protrusion 65 are respectively locked; therefore, the storage container 50 can be avoided from being mounted to the housing in an unstable state.

In a state where the detachable member 60 is locked to the housing connector 40, it is preferable that the grip portion 64 does not overlap the tapered portion 41a of the gripped portion 41 in the width direction U and that the tapered portion 41a is located closer to the container side surface 51 than the grip portion 64. In addition, it is more preferable that the grip portion 64 is caught on the tapered portion 41a when the grip portion 64 is moved.

When the pressing portion 63a is pressed in a direction in which the detachable side surface portion 62 is separated from the housing connector 40 as indicated by arrow F illustrated in FIG. 10, the extending portion 63 moves. At this time, a lower end portion of the extending portion 63 connected to the detachable facing portion 61 moves only slightly, but an upper end portion of the extending portion 63 not connected to the detachable facing portion 61 moves largely. In other words, the force pressing the pressing portion 63a efficiently acts so as to largely move the upper end portion with the lower end portion as a fulcrum, and thus the force can be avoided from being applied to an unexpected portion to deform the portion in a twisted manner. The extending portion 63 is moved so as to separate from the housing connector 40, and thus the locking of the grip portion 64 and the restriction protrusion 65 is released. In this case, since the gripped portion 41 has a tapered shape, the grip portion 64 can be prevented from being caught by the corner of the gripped portion 41. In other words, when the detachable side surface portion 62 is moved and the grip portion 64 is moved toward the tapered portion 41a side, the locking force is weakened, and the grip portion 64 is easily detached from the gripped portion 41.

The grip portion 64 is preferably formed in a shape flush with the detachable side surface portion 62. As just described, by reducing undulation of the grip portion 64 with respect to the surface along the detachable side surface portion 62 and displacing the detachable side surface portion 62 and the grip portion 64 in the same manner, a structure can be obtained in which the locking is easily released even when slight displacement is generated by weak force.

As described above, since the detachable member 60 itself is moved to release the locking, a structure that is easy to attach and detach can be achieved without providing a new member. Further, since the pressing portion 63a disposed on the same line as the grip portion 64 is pressed, the force for moving the grip portion 64 is easily transmitted, and thus operability of a user can be improved. Furthermore, the restriction protrusion 65 is provided at a portion that is not directly connected to the detachable facing portion 61, the restriction protrusion 65 can be largely moved when pressed, and thus a structure that is easy to release the locking can be achieved.

The insertion direction S of the storage container 50 is preferably opposite to a load applied to the storage container 50. Even when force is applied in a direction in which the storage container 50 is detached, the storage container 50 is restrained by the movement restriction portion, and thus the storage container 50 is prevented from being unexpectedly detached.

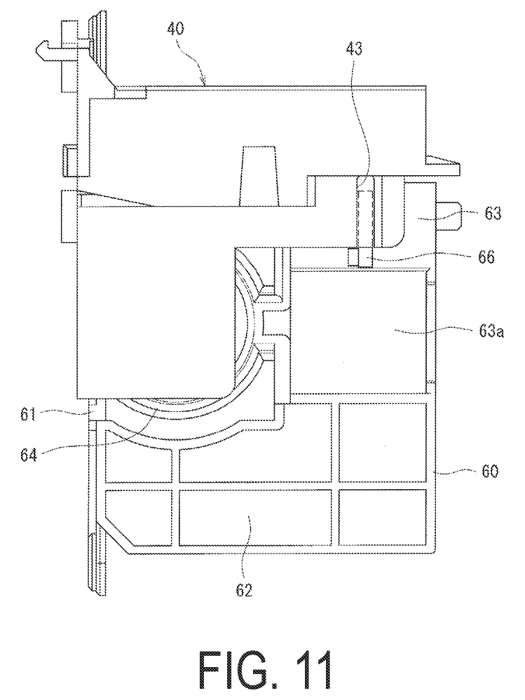

Next, a modification in which the configurations of the detachable member 60 and the housing connector 40 are different will be described with reference to FIG. 11.

FIG. 11 is a side view illustrating the detachable member and the housing connector in the modification.

In the modification, a restriction lever 66 (an example of the movement restriction portion) is provided instead of the restriction protrusion 65, and a locking groove 43 (an example of the locking portion) is provided instead of the locking hole 42. The restriction lever 66 is movably attached to an upper end portion of the extending portion 63. The locking groove 43 is formed by cutting out a portion facing the restriction lever 66. The restriction lever 66 is moved to be switched between a state of being locked to the locking groove 43 and a state of being unlocked from the locking groove 43. In FIG. 11, the restriction lever 66 is indicated by a solid line when unlocked from the locking groove 43, and is indicated by a broken line when locked in the locking groove 43. As illustrated in FIG. 11, when the restriction lever 66 is moved to enter the locking groove 43, the restriction lever 66 is caught, and thus the movement of the detachable member 60 is restricted. As just described, by providing the movable restriction lever 66, locking and unlocking can be easily switched.

Note that the embodiments disclosed herein are illustrative in all respects and do not form the basis for a limited interpretation. Accordingly, the technical scope of the disclosure is not to be construed only by the foregoing embodiments and is defined based on the description of the claims. In addition, meanings equivalent to the claims and all changes made within the claims are included.

While there have been described what are at present considered to be certain embodiments of the invention, it will be understood that various modifications may be made thereto, and it is intended that the appended claims cover all such modifications as fall within the true spirit and scope of the invention.

What is claimed is:

1. A storage container for toner to be inserted into a housing of an image forming apparatus in an insertion direction, the storage container comprising:
a grip portion that grips a gripped portion provided in the housing;
a movement restriction portion that is locked to a locking portion provided in the housing and restricts movement in the insertion direction.

2. The storage container according to claim 1, comprising:
a container facing surface that is orthogonal to the insertion direction and faces the housing;
a container side surface along the insertion direction; and
a detachable member provided with the grip portion and the movement restriction portion,
wherein the detachable member includes a detachable facing portion along the container facing surface and a detachable side surface portion along the container side surface, and
the grip portion and the movement restriction portion are provided on the detachable side surface portion.

3. The storage container according to claim 2, wherein
the detachable member is provided with a fixing portion on the detachable facing portion, the fixing portion being fixed to the container facing surface, and when the detachable side surface portion is pressed and moved, locking of the grip portion and the movement restriction portion is released.

4. The storage container according to claim 3, wherein
the detachable side surface portion includes a pressing portion that is pressed by a user when moving the detachable side surface portion, and the pressing portion is disposed on a straight line passing through the grip portion along the insertion direction.

5. The storage container according to claim 3, wherein
when a direction parallel to the container facing surface and orthogonal to the insertion direction is defined as a lever direction,
the detachable side surface portion has one end portion in the lever direction, which is connected to the detachable facing portion, and the other end portion in the lever direction at which the movement restriction portion is provided.

6. The storage container according to claim 5, wherein
the fixing portion is provided at a portion of the detachable facing portion, which is connected to the detachable side surface portion, and the grip portion is provided between the fixing portion and the movement restriction portion in the lever direction.

7. The storage container according to claim 1, wherein
the movement restriction portion is movably attached, and is moved to be switched between a state of being locked to the locking portion and a state of being unlocked from the locking portion.

8. An image forming apparatus, comprising:
the storage container according to claim 1.

9. The image forming apparatus according to claim 8, wherein
the gripped portion has an end portion on a side facing a side surface of the storage container, the end portion being formed in a tapered shape that is inclined.

10. The image forming apparatus according to claim 8, comprising:
a biasing member that biases the storage container mounted in the housing,
wherein the insertion direction is opposite to a biasing direction of the biasing member.
